(19) United States
(12) Patent Application Publication
(10) Pub. No.: US 2026/0341911 A1
(43) Pub. Date: Oct. 29, 2026

(54) SOLID-STATE BATTERY CELL AND METHOD FOR MANUFACTURING SOLID-STATE BATTERY CELL

(71) Applicant: HONDA MOTOR CO., LTD., Tokyo (JP)

(72) Inventors: Keisuke Tomida, Wako-shi (JP); Satoshi Yonezawa, Wako-shi (JP); Shohei Yoshida, Wako-shi (JP)

(21) Appl. No.: 19/458,979

(22) Filed: Jan. 26, 2026

(30) Foreign Application Priority Data
Feb. 27, 2025 (JP) 2025-030103

(51) Int. Cl. H01M 50/483; H01B 19/04; H01M 10/0525; H01M 50/474; H01M 50/477

(52) U.S. Cl. CPC H01M 50/483; H01B 19/04; H01M 10/0525; H01M 50/474; H01M 50/477; H01M 2300/0065

(57) ABSTRACT

Provided are a solid-state battery cell capable of releasing heat generated from a positive electrode to the outside and a method for manufacturing a solid-state battery cell. A solid-state battery cell including an electrode assembly including a positive electrode, a solid electrolyte layer, and a negative electrode and an insulating layer disposed to circulate an outer circumference of the electrode assembly, in which the insulating layer contains needle-like alumina particles.

### CROSS-REFERENCE TO RELATED APPLICATION

This application is based upon and claims the benefit of priority from Japanese Patent Application No. 2025-030103, filed Feb. 27, 2025, the entire content of which is incorporated herein by reference.

### BACKGROUND OF THE INVENTION

### Field of the Invention

The present invention relates to a solid-state battery cell and a method for manufacturing a solid-state battery cell.

### Description of Related Art

In a solid-state battery cell, an insulating layer is provided to surround the outer circumference of an electrode assembly to secure the insulating properties of the electrode assembly including a positive electrode, a solid electrolyte layer, and a negative electrode (for example, refer to Patent Document 1).

### Patent Documents

[Patent Document 1] Japanese Unexamined Patent Application, First Publication No. 2023-47083

### SUMMARY OF THE INVENTION

In a case where a positive electrode in an electrode assembly generates heat due to charge and discharge, the heat is likely to be confined in the electrode assembly surrounded by an insulating layer. When the heat is confined in the electrode assembly, the electrode assembly may deteriorate due to this heat.

In order to solve the above-described problem, the present application has an object of providing a solid-state battery cell capable of releasing heat generated in a positive electrode to the outside and a method for manufacturing a solid-state battery cell and contributes to the stabilization of battery performance and, furthermore, energy efficiency.

In order to achieve the above-described object, the present invention provides the following means.

[1] A solid-state battery cell including an electrode assembly including a positive electrode, a solid electrolyte layer, and a negative electrode and an insulating layer disposed to circulate an outer circumference of the electrode assembly,

in which the insulating layer contains needle-like alumina.

According to the above-described aspect, in the insulating layer, needle-like alumina particles are disposed close to one another, and heat paths are likely to be formed by the needle-like alumina, and it is thus possible to release heat generated in the electrode assembly due to charge and discharge to the outside of the solid-state battery cell through the needle-like alumina. The needle-like alumina is capable of transferring the heat in the length direction, and an effect of releasing the heat generated in the electrode assembly due to charge and discharge to the outside of the solid-state battery cell is thus superior to that of spherical alumina.

[2] The solid-state battery cell according to [1], in which the needle-like alumina is oriented in a direction toward an external surface of the insulating layer from an interface between the electrode assembly and the insulating layer.

According to the above-described aspect, the needle-like alumina is oriented in the direction toward the external surface of the insulating layer from the interface between the electrode assembly and the insulating layer, whereby it is possible to efficiently release the heat generated in the electrode assembly to the outside of the solid-state battery cell through the needle-like alumina that is contained in the insulating layer.

[3] The solid-state battery cell according to [1] or [2], in which a content of the needle-like alumina with respect to a total mass of the insulating layer is 20 mass% or more.

According to the above-described aspect, in the insulating layer, the needle-like alumina particles are disposed close to one another, and heat paths are likely to be formed by the needle-like alumina.

[4] The solid-state battery cell according to any one of [1] to [3], in which the needle-like alumina has a length of 50 μm or more and an aspect ratio of 100 or more.

According to the above-described aspect, in the insulating layer, the needle-like alumina particles are disposed close to one another, and heat paths are likely to be formed by the needle-like alumina.

[5] The solid-state battery cell according to any one of [1] to [4], in which the insulating layer contains spherical alumina.

According to the above-described aspect, the spherical alumina particles fill gaps between the needle-like alumina particles, the needle-like alumina particles are connected to one another through the spherical alumina particles, and heat paths are thus likely to be formed by the needle-like alumina.

[6] A method for manufacturing a solid-state battery cell including an electrode assembly including a positive electrode, a solid electrolyte layer, and a negative electrode and an insulating layer disposed to circulate an outer circumference of the electrode assembly, the method having: an insulating layer formation step of covering an outer circumference of the electrode assembly with an insulating composition containing needle-like alumina by a die coating method to form the insulating layer.

According to the above-described aspect, in the insulating composition, needle-like alumina particles are disposed close to one another, heat paths are likely to be formed by the needle-like alumina, and it is thus possible to form an insulating layer for releasing heat generated in the electrode assembly due to charge and discharge to the outside of the solid-state battery cell through the needle-like alumina.

[7] The method for manufacturing a solid-state battery cell according to [6], in which in a flow path of a slit die that is used in the die coating method, a flow rate of the insulating composition is controlled to become slower from a central portion of the flow path in a length direction toward an inner wall surface of the flow path.

According to the above-described aspect, in the flow path of the slit die, the flow rate of the insulating composition is controlled using a shear stress difference to become slower from the central portion of the flow path in the length direction toward the inner wall surface of the flow path to orient the needle-like alumina, whereby in the flow path of the slit die, the needle-like alumina flows along in a manner that a length direction thereof is along the length direction of the flow path, and it is thus possible to supply the needle-like alumina contained in the insulating composition that is ejected from an ejection opening of the slit die to the outer circumference of the electrode assembly in a state of being oriented in one direction.

[8] The method for manufacturing a solid-state battery cell according to [7], in which a width of an ejection opening of the slit die is 100 μm or more and 1000 μm or less.

According to the above-described aspect, it is possible to form an insulating layer in which the needle-like alumina is oriented in one direction.

[9] The method for manufacturing a solid-state battery cell according to any one of [6] to [8], the method further having:
a preparation step of preparing the insulating composition,
in which the preparation step has a first step of kneading an insulating material and spherical alumina to obtain a first kneaded substance and a second step of kneading the first kneaded substance and needle-like alumina to obtain a second kneaded substance.

According to the above-described aspect, in the insulating composition, the needle-like alumina particles are disposed close to one another, and heat paths are likely to be formed by the needle-like alumina.

The method for manufacturing a solid-state battery cell according to [9], in which the needle-like alumina has a length of 50 μm or more and an aspect ratio of 100 or more.

According to the above-described aspect, in the insulating composition, the needle-like alumina particles are disposed close to one another, and heat paths are likely to be formed by the needle-like alumina.

The method for manufacturing a solid-state battery cell according to [9] or , in which the spherical alumina particle has a particle diameter of 10 nm or more and 5000 nm or less.

According to the above-described aspect, in the insulating composition, the spherical alumina particles fill gaps between the needle-like alumina particles, the needle-like alumina particles are connected to one another through the spherical alumina particles, and heat paths are thus likely to be formed by the needle-like alumina.

According to the present invention, it is possible to provide a solid-state battery cell capable of releasing heat generated in a positive electrode to the outside and a method for manufacturing a solid-state battery cell.

### BRIEF DESCRIPTION OF THE DRAWINGS

FIG. 1 is a cross-sectional view illustrating a solid-state battery cell according to an embodiment of the present invention.

FIG. 2 is a cross-sectional view illustrating a slit die that is used in a method for manufacturing a solid-state battery cell according to an embodiment of the present invention.

### DETAILED DESCRIPTION OF THE INVENTION

Hereinafter, an embodiment of the present invention will be described in detail with reference to drawings.

### Solid-state battery cell

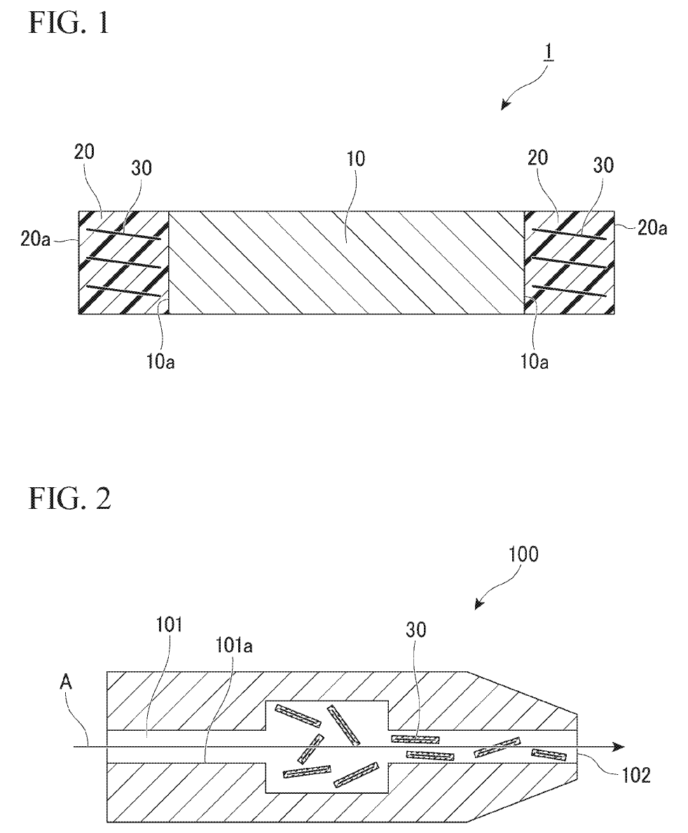

FIG. 1 is a cross-sectional view illustrating a solid-state battery cell according to the embodiment of the present invention. In the drawings to be used in the following description, there is a case where a characteristic portion is illustrated in an enlarged manner for convenience to facilitate the understanding of characteristics, and the dimensional ratio and the like of each component are not limited to those illustrated.

As illustrated in FIG. 1, a solid-state battery cell 1 of the present embodiment includes an electrode assembly 10 and an insulating layer 20. The insulating layer 20 is disposed to circulate the outer circumference of the electrode assembly 10. The insulating layer 20 contains needle-like alumina particles 30.

In the insulating layer 20, the needle-like alumina particles 30 are oriented in a direction toward an external surface (a surface opposite to an interface 10a) 20a of the insulating layer 20 from the interface 10a between the electrode assembly 10 and the insulating layer 20. Therefore, it is possible to efficiently release heat generated in the electrode assembly 10 to the outside of the solid-state battery cell 1 through the needle-like alumina particles 30 that are contained in the insulating layer 20.

The degree of orientation of the needle-like alumina particles 30 in the insulating layer 20 is preferably 30% or more, more preferably 60% or more, and still more preferably 80% or more. When the degree of orientation of the needle-like alumina particles 30 is the above-described lower limit value or more, it is possible to efficiently release heat generated in the electrode assembly 10 to the outside of the solid-state battery cell 1 through the needle-like alumina particles 30 that are contained in the insulating layer 20. Here, the degree of orientation of the needle-like alumina particles 30 in the insulating layer 20 refers to the proportion of the needle-like alumina particles 30 that are oriented in the same direction in the insulating layer 20 out of the needle-like alumina particles 30 that are contained in the insulating layer 20.

The degree of orientation of the needle-like alumina particles 30 in the insulating layer 20 can be measured by measurement with an X-ray CT device, measurement with a CT scanner, measurement by TMA measurement, or measurement by orientation tensor analysis.

The insulating layer 20 may contain spherical alumina.

The electrode assembly 10 has a positive electrode, a negative electrode, and a solid electrolyte layer.

### Positive electrode

The positive electrode is formed by laminating a first current collector foil and a positive electrode active material layer containing at least a positive electrode active material.

The first current collector foil is preferably made of at least one substance having high conductivity.

Examples of the highly conductive substance include metals or alloys containing at least any one metal element of silver (Ag), palladium (Pd), gold (Au), platinum (Pt), aluminum (Al), chromium (Cr), and nickel (Ni) and nonmetals of carbon (C). Aluminum, nickel, or stainless steel is preferable in consideration of the manufacturing cost in addition to high conductivity. Furthermore, aluminum is less likely to react with positive electrode active materials and electrolytes. Therefore, when aluminum is used in the first current collector foil, it is possible to reduce the internal resistance of the battery.

Examples of the shape of the first current collector foil include a foil shape, a plate shape, a mesh shape, a nonwoven fabric shape, a foamy shape, and the like. In addition, in order to enhance the adhesion to the positive electrode active material layer, carbon or the like may be disposed on the surface of the first current collector foil, and the surface may be roughened.

The positive electrode active material layer contains a positive electrode active material that gives and receives lithium ions and electrons. The positive electrode active material is not particularly limited as long as the positive electrode active material is a material capable of reversibly releasing and absorbing lithium ions and capable of electron transport, and it is possible to use a known positive electrode active material that can be applied to positive electrodes in lithium-ion batteries. Examples thereof include composite oxides such as lithium cobalt oxide (LiCoO₂), lithium nickel oxide (LiNiO₂), lithium manganese oxide (LiMn₂O₄), solid solution oxides (Li₂MnO₃-LiMO₂ (M = Co, Ni, or the like)), lithium-manganese-nickel-cobalt oxides (LiNiₓMn_{y}CozO₂, x + y + z = 1), and olivine-type lithium phosphate oxide (LiFePO₄); conductive polymers such as polyaniline and polypyrrole; sulfides such as Li₂S, CuS, Li-Cu-S compounds, TiS₂, FeS, MoS₂, and Li-Mo-S compounds; mixtures of sulfur and carbon; and the like. The positive electrode active material may be composed of one of the above-described materials only or may be composed of two or more thereof.

The positive electrode active material layer contains an electrolyte that gives and receives lithium ions to and from the positive electrode active material. The electrolyte is not particularly limited as long as the electrolyte has lithium ion conductivity, and it is possible to use a material that is generally used in lithium-ion batteries. Examples of the electrolyte include inorganic solid electrolytes such as sulfide solid electrolyte materials, oxide solid electrolyte materials, halide solid electrolytes, and lithium-containing salts, polymer-based solid electrolytes such as polyethylene oxide, and gel-based solid electrolytes containing a lithium-containing salt or a lithium-ion conductive ionic liquid, and the like. Among these, sulfide solid electrolyte materials are preferable from the viewpoint of highly conductive characteristics of lithium ions and favorable structural formability by pressing and interfacial bondability.

The electrolyte may be composed of one of the above-described materials only or may be composed of two or more thereof.

The electrolyte that is contained in the positive electrode active material layer may be the same material as or a different material from an electrolyte that is contained in a negative electrode active material layer or the solid electrolyte layer.

The positive electrode active material layer may contain a conductive auxiliary agent from the viewpoint of improving the conductivity of the positive electrode. As the conductive auxiliary agent, it is possible to use a conductive auxiliary agent that can be generally used in lithium-ion batteries. Examples thereof include carbon black such as acetylene black and Ketjen black; carbon fiber; vapor grown carbon fiber; graphite powder; carbon materials such as carbon nanotubes. The conductive auxiliary agent may be composed of one of the above-described materials only or may be composed of two or more thereof.

In addition, the positive electrode active material layer may contain a binder that plays a role of binding the molecules of the positive electrode active material and binding the positive electrode active material and the first current collector foil.

The first current collector foil is gathered in one end portion of the solid-state battery cell 1 in the width direction.

The positive electrode active material layer is in contact with the solid electrolyte layer and thus contains a sulfide that is contained in the solid electrolyte layer in some cases.

### Negative electrode

The negative electrode is formed by laminating a second current collector foil and a negative electrode active material layer containing at least a negative electrode active material.

The second current collector foil contains at least copper (Cu). The second current collector foil may contain, like the first current collector foil, a substance having high conductivity other than copper. Examples of the highly conductive substance other than copper include metals or alloys containing at least any one metal element of silver (Ag), palladium (Pd), gold (Au), platinum (Pt), chromium (Cr), and nickel (Ni) and nonmetals of carbon (C). As the substance other than copper, nickel or stainless steel is preferable in consideration of the manufacturing cost in addition to high conductivity. Furthermore, stainless steel is less likely to react with positive electrode active materials, negative electrode active materials, and electrolytes. Therefore, when stainless steel is used in the second current collector foil, it is possible to reduce the manufacturing cost of the battery.

Examples of the shape of the second current collector foil include a foil shape, a plate shape, a mesh shape, a nonwoven fabric shape, a foamy shape, and the like. In addition, in order to enhance the adhesion to the negative electrode active material layer, carbon or the like may be disposed on the surface of the second current collector foil, and the surface may be roughened.

The negative electrode active material layer contains a negative electrode active material that gives and receives lithium ions and electrons. The negative electrode active material is not particularly limited as long as the negative electrode active material is a material capable of reversibly releasing and absorbing lithium ions and capable of electron transport, and it is possible to use a known negative electrode active material that can be applied to negative electrodes in lithium-ion batteries. Examples thereof include carbonaceous materials such as natural graphite, artificial graphite, resin carbon, carbon fiber, activated carbon, hard carbon, and soft carbon; alloy-based materials mainly composed of tin, a tin alloy, silicon, a silicon alloy, gallium, a gallium alloy, indium, an indium alloy, aluminum, an aluminum alloy, or the like; conductive polymers such as polyacene, polyacetylene, and polypyrrole; metallic lithium; and lithium alloys such as lithium titanium composite oxides (for example, Li₄Ti₅O₁₂). These negative electrode active materials may be composed of one of the above-described materials only or may be composed of two or more thereof.

The negative electrode active material layer contains an electrolyte that gives and receives lithium ions to and from the negative electrode active material. The electrolyte is not particularly limited as long as the electrolyte has lithium ion conductivity, and it is possible to use a material that is generally used in lithium-ion batteries. Examples of the electrolyte include inorganic solid electrolytes such as sulfide solid electrolyte materials, oxide solid electrolyte materials, halide solid electrolytes, and lithium-containing salts, polymer-based solid electrolytes such as polyethylene oxide, and gel-based solid electrolytes containing a lithium-containing salt or a lithium-ion conductive ionic liquid, and the like. The electrolyte may be composed of one of the above-described materials only or may be composed of two or more thereof.

The electrolyte that is contained in the negative electrode active material layer may be the same material as or a different material from the electrolyte that is contained in the positive electrode active material layer or the solid electrolyte layer.

The negative electrode active material layer may contain a conductive auxiliary agent, a binder, and the like. These materials are not particularly limited, and it is possible to use, for example, the same materials as the above-described materials that are used in the positive electrode active material layer.

### Solid electrolyte layer

The solid electrolyte layer is disposed between the positive electrode active material layer and the negative electrode active material layer.

As the electrolyte, there is no particular limitations as long as the electrolyte has lithium ion conductivity and insulating properties, and it is possible to use a material that is generally used in lithium-ion batteries. Examples thereof include inorganic solid electrolytes such as sulfide solid electrolyte materials, oxide solid electrolyte materials, halide solid electrolytes, and lithium-containing salts, polymer-based solid electrolytes such as polyethylene oxide, and gel-based electrolytes containing a lithium-containing salt or a lithium-ion conductive ionic liquid, and the like. Among these, sulfide solid electrolyte materials are preferable from the viewpoint of highly conductive characteristics of lithium ions and favorable structural formability by pressing and interfacial bondability.

The form of the electrolyte material is not particularly limited, and examples thereof include a granular shape and the like.

The solid electrolyte layer may contain a pressure-sensitive adhesive for imparting mechanical strength or flexibility.

The solid electrolyte layer may have a sheet shape having a porous base material and a solid electrolyte held in the porous base material. The form of the porous base material is not particularly limited, and examples thereof include woven fabric, nonwoven fabric, mesh cloth, porous membranes, expanded sheets, punched sheets, and the like. Among these forms, nonwoven fabric is preferable from the viewpoint of handleability by which the filling amount of the solid electrolyte can be further increased.

The porous base material is preferably composed of an insulating material. This makes it possible to improve the insulating properties of the solid electrolyte layer. Examples of the insulating material include resin materials such as nylon, polyester, polyethylene, polypropylene, polytetrafluoroethylene, ethylene-tetrafluoroethylene copolymers, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resin; natural fibers such as hemp, wood pulp, and cotton linter, glass, and the like.

### Insulating layer

An insulating material that forms the insulating layer 20 is not particularly limited, and examples thereof include insulating oxides such as alumina, resins such as polyvinylidene fluoride (PVDF), rubbers such as styrene-butadiene rubber (SBR), and the like.

The needle-like alumina particle 30 is an elongated material, like a needle, composed of aluminum oxide (alumina). Alumina has high electrically insulating properties and a mechanical strength and has a relatively high thermal conductivity.

The lengths of the needle-like alumina particles 30 are preferably 0.5 μm or more, more preferably 50 μm or more, and still more preferably 200 μm or more. When the lengths of the needle-like alumina particles 30 are the above-described lower limit value or more, in the insulating layer 20, the needle-like alumina particles 30 are disposed close to one another, and heat paths are likely to be formed by the needle-like alumina particles 30. As a result, the effect of releasing heat generated in the electrode assembly 10 to the outside of the solid-state battery cell 1 through the needle-like alumina particles 30 that are contained in the insulating layer 20 is excellent.

The upper limit value of the lengths of the needle-like alumina particles 30 may be 5000 μm or less, may be 1000 μm or less, or may be 500 μm or less. When the upper limit value of the lengths of the needle-like alumina particles 30 is the above-described upper limit value or less, in the insulating layer 20, the shapes of the needle-like alumina particles 30 are maintained, and the effect of releasing heat generated in the electrode assembly 10 to the outside of the solid-state battery cell 1 through the needle-like alumina particles 30 that are contained in the insulating layer 20 is excellent.

The diameters (diameters in a cross section perpendicular to the length direction) of the needle-like alumina particles 30 are preferably 0.1 μm or more and 10 μm or less, more preferably 0.5 μm or more and 5 μm or less, and still more preferably 0.5 μm or more and 1 μm or less. When the diameters of the needle-like alumina particles 30 are the above-described lower limit value or more, the needle-like alumina particles 30 have excellent dispersibility and are likely to form uniform heat paths in the layer. When the diameters of the needle-like alumina particles 30 are the above-described upper limit value or less, the needle-like alumina particles 30 are likely to form a filling structure with a small number of voids and has a good influence on the heat exchange efficiency.

The aspect ratios of the needle-like alumina particles 30, that is, the ratios (the length of the needle-like alumina particle 30 to the diameter of the needle-like alumina particle 30) of the lengths of the needle-like alumina particles 30 to the diameters of the needle-like alumina particles 30 are preferably 10 or more, more preferably 40 or more, and still more preferably 100 or more. When the aspect ratios of the needle-like alumina particles 30 are the above-described lower limit value or more, in the insulating layer 20, the needle-like alumina particles 30 are disposed close to one another, and heat paths are likely to be formed by the needle-like alumina particles 30. As a result, the effect of releasing heat generated in the electrode assembly 10 to the outside of the solid-state battery cell 1 through the needle-like alumina particles 30 that are contained in the insulating layer 20 is excellent.

The upper limit value of the aspect ratios of the needle-like alumina particles 30 may be 1000 or less, may be 500 or less, or may be 200 or less. When the upper limit value of the aspect ratios of the needle-like alumina particles 30 is the above-described upper limit value or less, in the insulating layer 20, the shapes of the needle-like alumina particles 30 are maintained, and the effect of releasing heat generated in the electrode assembly 10 to the outside of the solid-state battery cell 1 through the needle-like alumina particles 30 that are contained in the insulating layer 20 is excellent.

The content of the needle-like alumina particles 30 with respect to the total mass (100 mass%) of the insulating layer 20 is preferably 1 mass% or more, more preferably 5 mass% or more, and still more preferably 20 mass% or more. When the content of the needle-like alumina particles 30 is the above-described lower limit value or more, in the insulating layer 20, the needle-like alumina particles 30 are disposed close to one another, and heat paths are likely to be formed by the needle-like alumina particles 30. As a result, the effect of releasing heat generated in the electrode assembly 10 to the outside of the solid-state battery cell 1 through the needle-like alumina particles 30 that are contained in the insulating layer 20 is excellent.

The upper limit value of the content of the needle-like alumina particles 30 with respect to the total mass (100 mass%) of the insulating layer 20 may be 99 mass% or less, may be 40 mass% or less. When the content of the needle-like alumina particles 30 is the above-described upper limit value or less, the mechanical strength of the insulating layer 20 is sufficiently maintained, and it is possible to curb the insulating layer 20 being broken by an external force.

The range of the content of the needle-like alumina particles 30 with respect to the total mass (100 mass%) of the insulating layer 20 may be is preferably 1 to 99 mass%, more preferably 5 to 40 mass%, and still more preferably 20 to 40 mass%.

The particle diameters of the spherical alumina particles are preferably 10 nm or more and 5000 nm or less, more preferably 100 nm or more and 3000 nm or less, and still more preferably 300 nm or more and 1000 nm or less. When the particle diameters of the spherical alumina particles are the above-described lower limit value or more, the dispersibility of the spherical alumina particles is excellent, and heat paths can be stably formed. When the particle diameters of the spherical alumina particles are the above-described upper limit value or less, the interfaces formed with adjacent layers become more uniform, and heat conduction becomes uniform.

The content of the spherical alumina particles with respect to the total mass (100 mass%) of the insulating layer 20 is preferably 10 mass% or more and 99 mass% or less, more preferably 50 mass% or more and 97 mass% or less, and still more preferably 85 mass% or more and 95 mass% or less. When the content of the spherical alumina particles is the above-described lower limit value or more, the distances between the spherical alumina particles and the needle-like alumina particles become close, and the spherical alumina particles are more likely to be affected by the formation of heat paths by the needle-like alumina particles.

According to the solid-state battery cell 1 of the present embodiment, in the insulating layer 20, since the needle-like alumina particles 30 are disposed close to one another, and heat paths are likely to be formed by the needle-like alumina particles 30, it is possible to release heat generated in the electrode assembly 10 due to charge and discharge to the outside of the solid-state battery cell 1 through the needle-like alumina particles 30. The needle-like alumina particles 30 are capable of transferring the heat in the length direction, and the effect of releasing the heat generated in the electrode assembly 10 due to charge and discharge to the outside of the solid-state battery cell 1 is thus superior to that of the spherical alumina particles.

### Method for manufacturing solid-state battery cell

FIG. 2 is a cross-sectional view illustrating a slit die that is used in a method for manufacturing a solid-state battery cell according to the embodiment of the present invention.

The method for manufacturing a solid-state battery cell of the present embodiment is a method for manufacturing a solid-state battery cell including an electrode assembly including a positive electrode, a solid electrolyte layer, and a negative electrode and an insulating layer disposed to circulate an outer circumference of the electrode assembly, the method having an insulating layer formation step of covering an outer circumference of the electrode assembly with an insulating composition containing needle-like alumina by a die coating method to form the insulating layer.

The method for manufacturing a solid-state battery cell of the present embodiment is a method for manufacturing, for example, the solid-state battery cell 1 of the above-described embodiment.

The method for manufacturing a solid-state battery cell of the present embodiment may have a preparation step of preparing the insulating composition. The preparation step has a first step of kneading an insulating material and spherical alumina to obtain a first kneaded substance and a second step of kneading the first kneaded substance and needle-like alumina to obtain a second kneaded substance.

The insulating material is not particularly limited, and it is possible to use, for example, an insulating oxide such as alumina, a resin such as polyvinylidene fluoride (PVDF), rubber such as styrene-butadiene rubber (SBR), or the like.

The particle diameter of the spherical alumina is preferably 10 nm or more and 5000 nm or less, more preferably 100 nm or more and 3000 nm or less, and still more preferably 300 nm or more and 1000 nm or less. When the particle diameter of the spherical alumina is the above-described lower limit value or more, the dispersibility of the spherical alumina is excellent, and heat paths can be stably formed. When the particle diameter of the spherical alumina is the above-described upper limit value or less, the interfaces formed with adjacent layers become more uniform, and heat conduction becomes uniform.

The content of the spherical alumina with respect to the total mass (100 mass%) of the first kneaded substance is preferably 10 mass% or more and 99 mass% or less, more preferably 50 mass% or more and 97 mass% or less, and still more preferably 85 mass% or more and 95 mass% or less. When the content of the spherical alumina is the above-described lower limit value or more, the distance between the spherical alumina and the needle-like alumina becomes close, and the spherical alumina is more likely to be affected by the formation of heat paths by the needle-like alumina particles.

A method for kneading the insulating material and the spherical alumina is not particularly limited, and examples thereof include planetary centrifugal mixing, continuous twin-screw mixing, orbiting-screw mixing, single-screw mixing, and the like.

The length of the needle-like alumina is preferably 0.5 μm or more, more preferably 50 μm or more, and still more preferably 200 μm or more. When the length of the needle-like alumina is the above-described lower limit value or more, in the insulating composition, the needle-like alumina particles are disposed close to one another, and heat paths are likely to be formed by the needle-like alumina.

The upper limit value of the length of the needle-like alumina may be 5000 μm or less, may be 1000 μm or less, or may be 500 μm or less. When the upper limit value of the length of the needle-like alumina is the above-described upper limit value or less, it is possible to prepare the insulating composition while the shape of the needle-like alumina is maintained.

The diameter (diameter in a cross section perpendicular to the length direction) of the needle-like alumina is preferably 0.1 μm or more and 10 μm or less, more preferably 0.5 μm or more and 5 μm or less, and still more preferably 0.5 μm or more and 1 μm or less. When the diameter of the needle-like alumina is the above-described lower limit value or more, the needle-like alumina has excellent dispersibility and is likely to form uniform heat paths in the layer. When the diameter of the needle-like alumina is the above-described upper limit value or less, the needle-like alumina is likely to have a filling structure with a small number of voids and has a good influence on the heat exchange efficiency.

The aspect ratio of the needle-like alumina, that is, the ratio (the length of the needle-like alumina to the diameter of the needle-like alumina) of the length of the needle-like alumina to the diameter of the needle-like alumina is preferably 10 or more, more preferably 40 or more, and still more preferably 100 or more. When the aspect ratio of the needle-like alumina is the above-described lower limit value or more, in the insulating composition, the needle-like alumina particles are disposed close to one another, and heat paths are likely to be formed by the needle-like alumina.

The upper limit value of the aspect ratio of the needle-like alumina may be 1000 or less, may be 500 or less, or may be 200 or less. When the upper limit value of the aspect ratio of the needle-like alumina is the above-described upper limit value or less, it is possible to prepare the insulating composition while the shape of the needle-like alumina is maintained.

The content of the needle-like alumina with respect to the total mass (100 mass%) of the second kneaded substance is preferably 1 mass% or more, more preferably 5 mass% or more, and still more preferably 20 mass% or less. When the content of the needle-like alumina is the above-described lower limit value or more, in the insulating composition, the needle-like alumina particles are disposed close to one another, and heat paths are likely to be formed by the needle-like alumina.

In the insulating layer formation step, the outer circumference of the electrode assembly is covered with the insulating composition containing the needle-like alumina by a die coating method, thereby forming the insulating layer.

In the insulating layer formation step, in a flow path 101 of a slit die 100 illustrated in FIG. 2, the flow rate of the insulating composition is controlled to become gradually slower from the central portion of the flow path 101 in the length direction (the flow direction of the insulating composition (a direction of an arrow A illustrated in FIG. 2)) toward an inner wall surface 101a of the flow path 101. In order to control the flow rate of the insulating composition to become gradually slower from the central portion of the flow path 101 in the length direction toward the inner wall surface 101a of the flow path 101, a shear stress difference is used in the flow path 101 of the slit die 100. This makes the needle-like alumina particles 30 flow in a manner that the length directions thereof are along the direction of the arrow A illustrated in FIG. 2 in the flow path 101, and the needle-like alumina contained in the insulating composition that is ejected from an ejection opening 102 of the slit die 100 is supplied to the outer circumference of the electrode assembly in a state of being oriented in one direction.

According to the method for manufacturing a solid-state battery cell of the present embodiment, since the needle-like alumina particles are disposed close to one another, and heat paths are likely to be formed by the needle-like alumina, it is possible to form an insulating layer for releasing heat generated in the electrode assembly due to charge and discharge to the outside of the solid-state battery cell through the needle-like alumina.

Hitherto, the embodiment of the present invention has been described in detail, but the present invention is not limited to the above-described embodiment, and a variety of transformations and changes are possible within the scope of the gist of the present invention described in the claims.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Solid-state battery cell
10 Electrode assembly
20 Insulating layer
30 Needle-like alumina particle
100 Slit die
101 Flow path
102 Ejection opening

What is claimed is:

1. A solid-state battery cell comprising:
an electrode assembly including a positive electrode, a solid electrolyte layer, and a negative electrode; and
an insulating layer disposed to circulate an outer circumference of the electrode assembly,
wherein the insulating layer contains needle-like alumina.

2. The solid-state battery cell according to claim 1, wherein the needle-like alumina is oriented in a direction toward an external surface of the insulating layer from an interface between the electrode assembly and the insulating layer.

3. The solid-state battery cell according to claim 1, wherein a content of the needle-like alumina with respect to a total mass of the insulating layer is 20 mass% or more.

4. The solid-state battery cell according to claim 1, wherein the needle-like alumina has a length of 50 μm or more and an aspect ratio of 100 or more.

5. The solid-state battery cell according to claim 1, wherein the insulating layer contains spherical alumina.

6. A method for manufacturing a solid-state battery cell including an electrode assembly including a positive electrode, a solid electrolyte layer, and a negative electrode and an insulating layer disposed to circulate an outer circumference of the electrode assembly, the method comprising:
an insulating layer formation step of covering an outer circumference of the electrode assembly with an insulating composition containing needle-like alumina by a die coating method to form the insulating layer.

7. The method for manufacturing a solid-state battery cell according to claim 6, wherein in a flow path of a slit die that is used in the die coating method, a flow rate of the insulating composition is controlled to become slower from a central portion of the flow path in a length direction toward an inner wall surface of the flow path.

8. The method for manufacturing a solid-state battery cell according to claim 7, wherein a width of an ejection opening of the slit die is 100 μm or more and 1000 μm or less.

9. The method for manufacturing a solid-state battery cell according to claim 6, the method further comprising:
a preparation step of preparing the insulating composition,
wherein the preparation step has a first step of kneading an insulating material and spherical alumina to obtain a first kneaded substance and a second step of kneading the first kneaded substance and needle-like alumina to obtain a second kneaded substance.

10. The method for manufacturing a solid-state battery cell according to claim 9, wherein the needle-like alumina has a length of 50 μm or more and an aspect ratio of 100 or more.

11. The method for manufacturing a solid-state battery cell according to claim 9, wherein the spherical alumina particle has a particle diameter of 10 nm or more and 5000 nm or less.
